(19) United States
(12) Patent Application Publication
(10) Pub. No.: US 2014/0340344 A1
(43) Pub. Date: Nov. 20, 2014

(54) DISPLAY PROCESSOR AND DISPLAY PROCESSING METHOD

(71) Applicant: Kabushiki Kaisha Toshiba, Tokyo (JP)

(72) Inventor: Masahiro YAMADA, Nishitama Tokyo (JP)

(21) Appl. No.: 14/448,585

(22) Filed: Jul. 31, 2014

Related U.S. Application Data
(63) Continuation of application No. PCT/JP2013/059732, filed on Mar. 29, 2013.

(51) Int. Cl. G06F 3/14; G06F 3/0488; G06F 3/0481; G06F 3/041

(52) U.S. Cl. CPC G06F 3/1454; G06F 3/0416; G06F 3/0488; G06F 3/04817
USPC 345/173

(57) ABSTRACT

According to one embodiment, processor includes an acquisition module, a communication module, an output module, and a controller. The acquisition module acquires detection information indicating that an object has been detected around a region on which a display device performs displaying. The output module outputs, to a display, screen information on which display information indicating data is arranged, and outputs, to the display when communication between the communication module and a terminal becomes available, the display information indicating data capable of being used by the terminal in a display mode different from other display information based on attribute information indicating an attribute of the terminal. The attribute information is received from the terminal. The controller establishes, when the terminal is detected around the display region, communication of the data indicated by the display information between the communication module and the terminal based on the detection information and the attribute information.

### CROSS-REFERENCE TO RELATED APPLICATIONS

This application is a continuation of International Application No. PCT/JP2013/059732, filed on Mar. 29, 2013, which designates the United States, the entire contents of which are incorporated herein by reference.

### FIELD

Embodiments described herein relate generally to a display processor and a display processing method.

### BACKGROUND

Conventionally, there has been known a display processor with a user interface by a touch panel. The display processor performs processing based on data related to an icon when a user touches the icon or the like displayed on the user interface with the user's finger or a specified terminal, for example.

For example, there has been known the following technique. That is, when the user touches the icon or the like that is displayed by the display processor with a communication terminal, data corresponding to the touched icon is transmitted and received between the communication terminal and the display processor.

In the conventional technique, data formats capable of being used by the communication terminal are restricted. It is difficult for the user to know whether data can be used by the communication terminal with the icon displayed on the user interface.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a hardware configuration of a display processor according to an embodiment;

FIG. 2 is an exemplary view illustrating a variation in which images are displayed on a wall surface by using a projector as a display in the embodiment;

FIG. 3 is an exemplary view illustrating a data structure of an icon data table stored in an icon storage module in the embodiment;

FIG. 4 is an exemplary diagram illustrating a hardware configuration of a mobile terminal in the embodiment;

FIGS. 5A to 5C are exemplary views illustrating an example of a user interface screen when the display processor executes a terminal link program in the embodiment;

FIG. 6 is an exemplary view illustrating a variation of a first screen on which icons indicating pieces of data capable of being used by the mobile terminal are displayed in a display mode different from that of other icons in the embodiment;

FIG. 7 is an exemplary view illustrating a variation of a second screen on which icons indicating pieces of data capable of being used by the mobile terminal are displayed in a display mode different from that of other icons in the embodiment;

FIG. 8 is an exemplary diagram illustrating a timing chart when link processing between the display processor and the mobile terminal is performed in the embodiment;

FIG. 9 is an exemplary diagram illustrating a timing chart when link processing between the display processor and a plurality of mobile terminals is performed in the embodiment;

FIG. 10 is an exemplary view illustrating an example of a screen on which icons indicating pieces of data capable of being used by the respective mobile terminals are displayed in display modes different from that of other icons in the embodiment;

FIGS. 11A to 11E are exemplary views illustrating an example of screen transition by display control of an output module in the embodiment;

FIG. 12 is an exemplary view illustrating an example of destinations of icons by the output module in the embodiment;

FIG. 13 is an exemplary view illustrating arrangement of the mobile terminal when data is downloaded from the display processor in the embodiment;

FIGS. 14A to 14C are exemplary views illustrating an example of transition of screen information output from the output module in the embodiment;

FIGS. 15A to 15E are exemplary views illustrating a first example of the transition of the screen information output from the output module according to a modification;

FIGS. 16A to 16C are exemplary views illustrating a second example of the transition of the screen information that is output from the output module according to another modification;

FIG. 17 is an exemplary view illustrating an example of a screen on which a log-in button in a changed display mode is arranged by the output module in the embodiment;

FIGS. 18A and 18B are exemplary views illustrating another example of the screen on which a log-in button in a changed display mode is arranged by the output module in the embodiment; and

FIG. 19 is an exemplary flowchart illustrating processing until the display processor starts communication with the mobile terminal in the embodiment.

### DETAILED DESCRIPTION

In general, according to one embodiment, a display processor comprises an acquisition module, a communication module, an output module, and a communication controller. The acquisition module is configured to acquire detection information indicating that an object has been detected around a display region on which a display device performs displaying. The communication module is configured to be capable of transmitting and receiving data to and from a communication terminal. The output module is configured to output, to a display, screen information on which display information indicating data is arranged, and to output, to the display when communication between the communication module and the communication terminal becomes available, the display information indicating data capable of being used by the communication terminal in a display mode different from other display information based on attribute information indicating an attribute of the communication terminal. The attribute information is received from the communication terminal. The communication controller is configured to establish, when the communication terminal is detected around the display region, communication of the data indicated by the display information in the display mode different from the other display information by the output module between the communication module and the communication terminal based on the detection information acquired by the acquisition module and the attribute information received from the communication terminal.

Hereinafter, embodiments to which a display processor and a display processing method are applied are described with reference to the drawings. It should be noted that these embodiments do not limit the invention.

The display processor in the embodiment displays a user interface screen on a touch panel-type display. The display processor executes predetermined processing by detecting touch onto the user interface screen. The mobile terminal is a portable communication terminal. For example, a smart phone can be used for the mobile terminal. Alternatively, other dedicated devices may be used for the mobile terminal. For example, the mobile terminal may be a device having a pen-like shape.

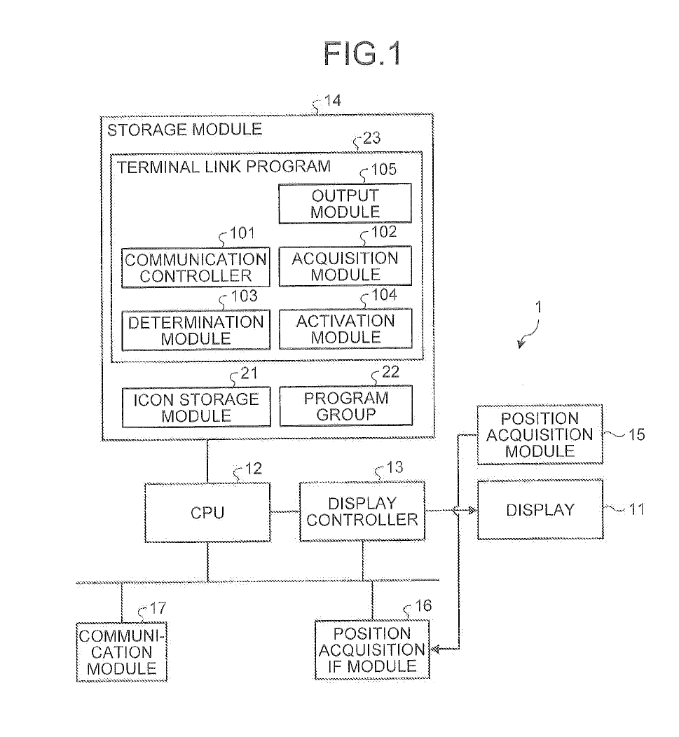

FIG. 1 is a diagram illustrating a hardware configuration of a display processor 1 in the embodiment. As illustrated in FIG. 1, the display processor 1 comprises a display 11, a central processing unit (CPU) 12, a display controller 13, a storage module 14, a position acquisition module 15, a position acquisition interface (IF) module 16, and a communication module 17.

The display 11 is configured by a liquid crystal display panel or the like, and displays the user interface screen for a user. The CPU 12 controls the display processor 1 overall. In accordance with control by the CPU 12, the display controller 13 converts information and the user interface screen on the display 11 in a form of images, and draws the information and the user interface.

The position acquisition module 15 acquires position coordinates at which the user touches the display 11. The position acquisition module 15 is configured by a touch sensor film bonded to the surface of the display 11. Sensors are aligned on the touch sensor film in the X-axis direction and the Y-axis direction. When the user touches the screen with the user's hand or finger, a mobile terminal, or the like, the touch sensor film detects the touch. The touch sensor film outputs a detection signal containing the touched position coordinates to the position acquisition IF module 16. The above-mentioned expression “touch” is not limited to the state in which an object actually touches the display 11, and may encompass a state in which it substantially touches the display 11.

The position acquisition IF module 16 outputs the detection signal (containing the position coordinates detected by the touch sensor film) input from the position acquisition module 15 to the CPU 12.

The position acquisition module 15 may be an optical touch sensor. The optical touch sensor may employ a system that detects the presence of the object by detecting transmission and shielding of light. Alternatively, the optical touch sensor may employ a system that detects the presence of the object from an image acquired by a camera.

As the display processor 1 in the embodiment, a television display device on which the touch panel is mounted can be employed, for example. Note that the display processor 1 is not limited to such a device.

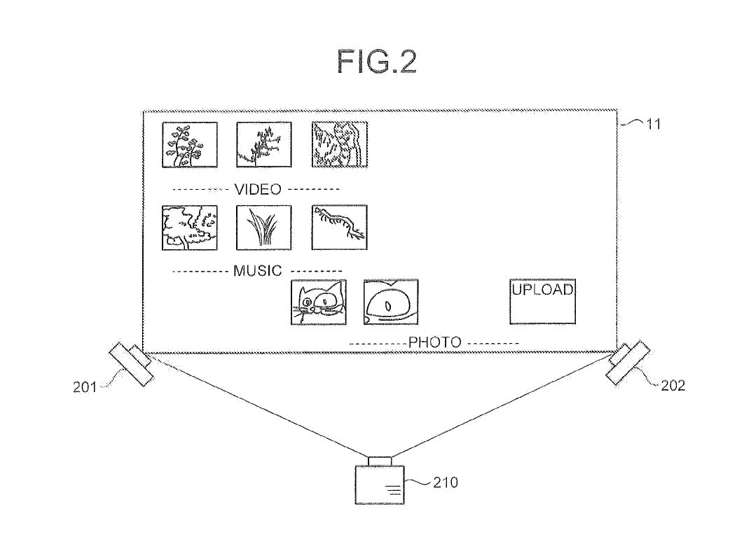

FIG. 2 is a view illustrating a variation in which images are displayed on a wall surface by using a projector 210 as the display 11. In the example of FIG. 2, optical touch sensors 201 and 202 as the position acquisition module are comprised for detecting a touched position when the user touches the wall surface onto which images have been projected. Even in the variation, the same effects can be achieved by the same processing as that in the embodiment. Furthermore, the position acquisition module is not limited to the optical touch sensors 201 and 202. Alternatively, an image acquiring camera or the like may be employed or the touch sensor film may be used as in the embodiment.

The display processor is not limited to a device comprising therein a display device and any display processor that perform display processing are applied. The display processor may be a set top box on which a display device comprising a touch sensor is attached externally, a computer, or the like. A monitor of the computer has been well-known as the display device comprising the touch sensor. For example, a signal from the touch sensor is input to the display processor through a universal serial bus (USB) terminal.

Returning back to the embodiment as illustrated in FIG. 1, the communication module 17 is configured to enable the display processor 1 to transmit and receive data to and from other terminals (for example, communication terminal). For example, the communication module 17 performs transmission and reception of data to and from a mobile terminal through the Bluetooth (registered trademark) or the wireless local area network (LAN), and Internet communication through the wireless LAN, and the like.

The storage module 14 is configured by a storage medium such as a read only memory (ROM) and a random access memory (RAM) that can store therein information. The storage module 14 comprises an icon storage module 21, a program group 22, and a terminal link program 23.

The icon storage module 21 stores therein pieces of image data of icons that are displayed on the user interface screen, computer programs for performing pieces of processing when the icons are touched, and pieces of positional information indicating display positions of the icons on a display region of the display 11 in a correspondence manner.

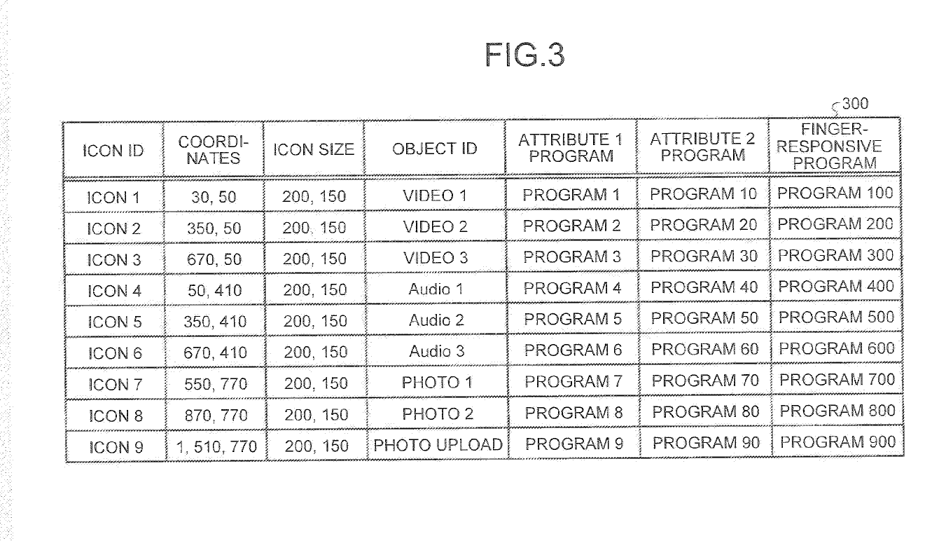

FIG. 3 is a view illustrating a data structure of an icon data table 300 stored in the icon storage module 21. As illustrated in FIG. 3, the icon data table 300 stores therein icon IDs, (position) coordinates, icon sizes, object IDs, and computer programs in a correspondence manner in one record. The icon IDs are pieces of identification information of the icons. The (position) coordinates are examples of positions when the icons are displayed on the display 11. The object IDs specify pieces of image data that are used for the icons. The programs are activated based on attributes of terminals.

The image data of each icon that is defined by the object ID is drawn on the display 11 at a position indicated by the (position) coordinates in accordance with control by the CPU 12. The icon data table 300 in the embodiment stores therein computer programs of three types, an attribute 1 program, an attribute 2 program, and a finger-responsive program, corresponding to each icon ID, as the programs that are activated when the icon is touched. The attribute 1 program is activated when a mobile terminal having an attribute 1 touches the icon. The attribute 2 program is activated when a mobile terminal having an attribute 2 touches the icon. The finger-responsive program is activated when an object (for example, user's finger) other than the mobile terminals touches the icon.

The computer programs herein are not limited to those having different execution codes. Computer programs that have the same execution code but pass different arguments are expressed as different programs. For example, computer programs that activate a web browser but pass different uniform resource locators (URLs), or computer programs that are message display programs but pass different messages are also expressed as different programs.

Returning back to FIG. 1, the program group 22 stores therein computer programs that are executed by the display processor 1. For example, the program group 22 comprises the above-mentioned attribute 1 program, attribute 2 program, finger-responsive program, and the like.

The terminal link program 23 comprises a communication controller 101, an acquisition module 102, a determination module 103, an activation module 104, and an output module 105. When touch to the display 11 is detected, the terminal link program 23 activates the program comprised in the program group 22 or performs control to transmit and receive data.

The communication controller 101 establishes communication with the mobile terminal by using the communication module 17 and transmits and receives data to and from the mobile terminal. For example, the communication controller 101 receives attribute information indicating the attribute of the mobile terminal from the mobile terminal. Furthermore, the communication controller 101 receives an acceleration detection signal indicating acceleration generated on the mobile terminal and an inclination detection signal.

The attribute information contains a data format capable of being used by the mobile terminal, a model name of the mobile terminal as a transmission source, a terminal type indicating a camera or an audio player, inclination information detected by the mobile terminal, and terminal authentication information. In addition, the attribute information may contain a size of a video image data that can be displayed. Moreover, the attribute information contains an operation mode (operation state) indicating a reproduction mode, a data transmission mode, a data reception mode, or the like, a data size that can be used, terminal authentication information, and key information for the mobile terminal.

The output module 105 outputs screen information on which icons are arranged to the display 11 for displaying it on the display region of the display 11. The icons express various pieces of data.

The acquisition module 102 acquires detection information indicating that the display region of the display 11 has been touched based on the detection signal input from the position acquisition module 15 through the position acquisition IF module 16. The acquired detection information contains touched position coordinates on the display region of the display 11 in addition to the presence or absence of the detection.

When communication is established by control by the communication controller 101 and communication with the mobile terminal becomes available, the determination module 103 determines whether the mobile terminal can use various pieces of data indicated by the icons based on the attribute information of the mobile terminal. In the embodiment, described is an example in which the determination module 103 determines whether the mobile terminal can use the pieces of data based on the format or the like contained in the attribute information. Note that the determination criterion is not limited to the format or the like contained in the attribute information. It is sufficient that the determination module 103 can determine whether the mobile terminal can use the pieces of data based on the attribute and the condition of the mobile terminal.

The output module 105 outputs the icons indicating the pieces of data capable of being used by the mobile terminal with which communication has become available based on the determination result by the determination module 103 to the display 11 while making the display mode thereof different from that of other icons. The specific display mode will be described later.

Furthermore, the determination module 103 specifies the mobile terminal that has touched the display 11 based on time at which the acquisition module 102 has acquired the detection information from the mobile terminal (in other words, time at which it has detected the touch) and time at which the communication controller 101 has received the acceleration detection signal. In the embodiment, the determination module 103 determines the mobile terminal as a transmission source of the acceleration detection signal to be the mobile terminal that has touched the display 11 when the time difference between the time at which the acquisition module 102 has detected the touch and the time at which the communication controller 101 has received the acceleration detection signal is equal to or smaller than a predetermined threshold. The threshold is assumed to be defined in accordance with an execution mode.

The determination module 103 specifies a computer program to be activated based on the attribute of the specified mobile terminal, the icon data table 300, and the position coordinates contained in the acceleration detection signal. This enables the program corresponding to the attribute of the mobile terminal to be activated.

The activation module 104 activates the program specified by the determination module 103. For example, in the example as illustrated in FIG. 3, when an “ICON 1” is detected to be touched, if the mobile terminal corresponds to the “ATTRIBUTE 1 PROGRAM”, the activation module 104 activates a “PROGRAM 1” corresponding to the attribute 1. It is not necessarily required that the position coordinates of the position at which the mobile terminal has touched the “ICON 1” and the position coordinates related to the icon are identical or overlapped. For example, when these position coordinates are close such that a distance therebetween is equal to or smaller than a predetermined value, the activation module 104 may activate the program corresponding to the icon.

Then, after the mobile terminal (mobile terminal that can make communication with the display processor 1) that has touched the icon is specified based on the determination result by the determination module 103, when the communication controller 101 transmits and receives data indicated by the icon to and from the mobile terminal, the output module 105 displays animation on the display region of the display 11. The icon is moved with reference to the position at which the touch by the mobile terminal has been detected on the animation.

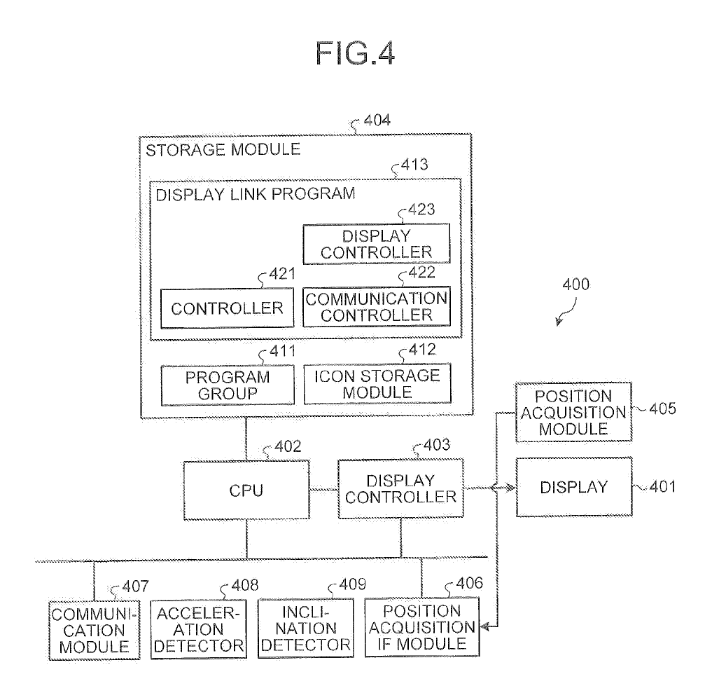

FIG. 4 is a diagram illustrating a hardware configuration of a mobile terminal 400 in the embodiment. As illustrated in FIG. 4, the mobile terminal 400 comprises a display 401, a CPU 402, a display controller 403, a storage module 404, a position acquisition module 405, a position acquisition interface (IF) module 406, a communication module 407, an acceleration detector 408, and an inclination detector 409.

The display 401, the CPU 402, the display controller 403, the position acquisition module 405, the position acquisition interface (IF) module 406, and the communication module 407 comprised in the mobile terminal 400 perform the same pieces of processing as those of the display 11, the CPU 12, the display controller 13, the position acquisition module 15, the position acquisition IF module 16, and the communication module 17 comprised in the display processor 1, respectively, and description thereof is omitted. It is assumed that the display 401 of the mobile terminal 400 in the embodiment has a screen size smaller than that of the display 11 of the display processor 1.

The acceleration detector 408 detects acceleration from an acceleration sensor provided on the mobile terminal 400 and outputs acceleration information to the CPU 402.

The inclination detector 409 detects an inclination from an inclination sensor provided on the mobile terminal 400 and outputs inclination information to the CPU 402.

The storage module 404 is configured by a storage medium such as a read only memory (ROM) and a random access memory (RAM) that can store therein information. The storage module 404 comprises an icon storage module 412, a program group 411, and a display link program 413.

The icon storage module 412 stores therein pieces of image data of icons that are displayed on the user interface screen, computer programs for performing pieces of processing when the icons are touched, and pieces of positional information indicating display positions of the icons on the user interface of the display 401 in a correspondence manner as in the icon storage module 21 of the display processor 1.

The program group 411 stores therein computer programs for enabling data (for example, video image data, audio data, picture data) to be reproduced and displayed by the mobile terminal 400.

The display link program 413 comprises a controller 421, a communication controller 422, and a display controller 423. The display link program 413 is resident in the mobile terminal 400 and performs control for linking with the display processor 1.

The controller 421 sets data that is reproduced and displayed by the program group 411 to be a transmission target when the mobile terminal 400 transmits the data to the display processor 1.

When communication between the mobile terminal 400 and the display processor 1 is established, the communication controller 422 performs control to transmit the attribute information indicating the attribute of the mobile terminal 400. Furthermore, the communication controller 422 performs transmission control of the data set by the controller 421 when it performs transmission control of data to the display processor 1

When the communication controller 422 receives data from the display processor 1, the display controller 423 displays animation on which an icon indicating the data received by the communication controller 422 is moved from the outside of the display region of the display 401. When the communication controller 422 transmits data to the display processor 1, the display controller 423 displays animation on which an icon indicating the data transmitted by the communication controller 422 is moved to the outside of the display region of the display 401.

The transmission and reception of data are performed between the display processor 1 and the mobile terminal 400 as described above. In the embodiment, an operation on the user interface screen of the display processor 1 triggers the transmission and reception of data.

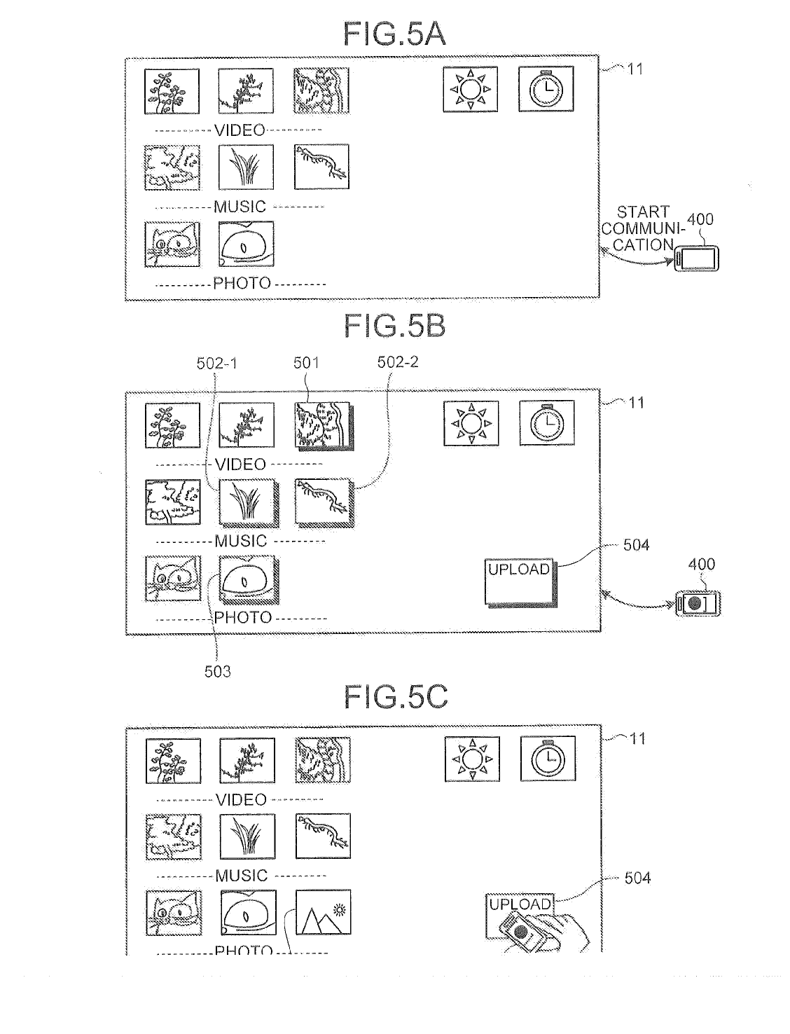

FIGS. 5A to 5C are views illustrating an example of the user interface screen when the display processor 1 executes the terminal link program 23 in the embodiment. As illustrated in FIG. 5A, the display 11 of the display processor 1 displays three pieces of video image data, three pieces of music data, and two pieces of picture data that are stored in the storage module 14 with icons of different types. Furthermore, an icon indicating a clock, and an icon indicating weather forecast are displayed.

When a user touches a region on the touch panel on which the video image icon, the music icon, or the picture icon is displayed with the user's finger, the display processor 1 reproduces and displays it. On the other hand, when the region is touched with the mobile terminal 400, download of data thereof is started if it can be used by the mobile terminal 400. Furthermore, when the user touches the icon indicating the weather or the icon indicating the clock with the user's finger, details thereof are displayed. When it is touched with the mobile terminal 400, the same processing is performed or no response is made, and download is not performed.

In the screen example as illustrated in FIG. 5A, the user cannot distinguish icons of which pieces of data are started to be downloaded when the user touches them with the mobile terminal 400. For this reason, the user may keep touching an icon indicating data incapable of being downloaded with the mobile terminal 400.

Furthermore, when the mobile terminal is made to touch the touch panel, the user even cannot determine whether the mobile terminal has a function of downloading data. On the screen of FIG. 5A, all the user can do is to make the mobile terminal touch the respective icons displayed on the touch panel blindly for checking. Due to this, the user repeatedly touches the touch panel with the mobile terminal many times because data is not downloaded, strong impact is given onto the touch panel. The impact possibly causes failure.

Therefore, in the embodiment, display modes of the icons indicating pieces of data capable of being downloaded and the icons indicating pieces of data incapable of being downloaded are made different.

When the user desires to make communication with the display processor 1 by using the mobile terminal 400, the display link program 413 of the mobile terminal 400 for establishing data communication with the display processor 1 is activated. The display link program 413 waits for a communication request from the display processor 1, and responds to it if there is the communication request. Furthermore, the display link program 413 issues a communication request to the terminal link program 23 of the display processor 1 waiting for the communication request. This enables the display processor 1 to establish communication with the mobile terminal 400. With this, the display processor 1 knows that the mobile terminal 400 with which it can make data communication is present.

When there is only one mobile terminal having the function, when a communication range of the LAN is narrow, and so on, the display link program 413 may be activated before the mobile terminal enters a service area of the LAN through which it can make communication with the display processor 1.

The communication for download is started between the display processor 1 and the mobile terminal 400 between which communication is established. With this, the attribute information indicating the attribute of the mobile terminal 400 is transmitted to the display processor 1.

In an example as illustrated in FIG. 5B, data formats of a leftmost icon and a second icon from the left are set to ITU H263, and a data format of a rightmost icon is set to ITU H264 among three video image icons aligned on “VIDEO”. A data format of a leftmost icon is set to AIFF, and data formats of a second icon from the left and a rightmost icon are set to MP3 among three music icons aligned on “MUSIC”.

The determination module 103 can recognize that the mobile terminal 400 supports ITU H264, MPEG2, MP3, and AAC based on the attribute information received from the mobile terminal 400.

When data communication with the mobile terminal 400 is started, a screen as illustrated in FIG. 5B is displayed. In the example as illustrated in FIG. 5B, the output module 105 outputs icons indicating pieces of data capable of being used by the mobile terminal 400 in a display mode different from that of other icons to the display 11 based on the determination result whether the pieces of data are capable of being used by the mobile terminal 400 by the determination module 103.

Furthermore, an upload icon 504 newly is displayed. The upload icon 504 is an icon for uploading data onto the display processor 1 when it is touched by the mobile terminal 400. Note that when the user touches the upload icon 504 with the user's finger, the data cannot be uploaded. For this reason, the upload icon 504 is not displayed when the mobile terminal is not found and is displayed when the mobile terminal is found.

In FIG. 5B, as the display mode different from that of other icons, icons 501 (ITU H264), 502_1, 502_2 (MP3), and 503 are displayed in a raised manner (such that shades thereof are emphasized). The mobile terminal 400 can also use the upload icon 504, so that the upload icon 504 is displayed in the raised manner (shade thereof is emphasized). Whether data can be used by the mobile terminal 400 is determined based on the attribute information.

The display modes of the icons other than the icons 501 (ITU H264), 502_{—l 1, 502}_2 (MP3), and 503 are not changed. That is, data communication is not performed even when the icons other than the icons 501 (ITU H264), 502_1, 502_2 (MP3), and 503 are touched by the mobile terminal 400.

A message indicating that an interaction with the display processor 1 becomes available may be displayed on the screen of the mobile terminal 400 after the display processor 1 receives the attribute information of the mobile terminal 400. In the example as illustrated in FIG. 5B, a mark•is displayed on the screen of the mobile terminal 400.

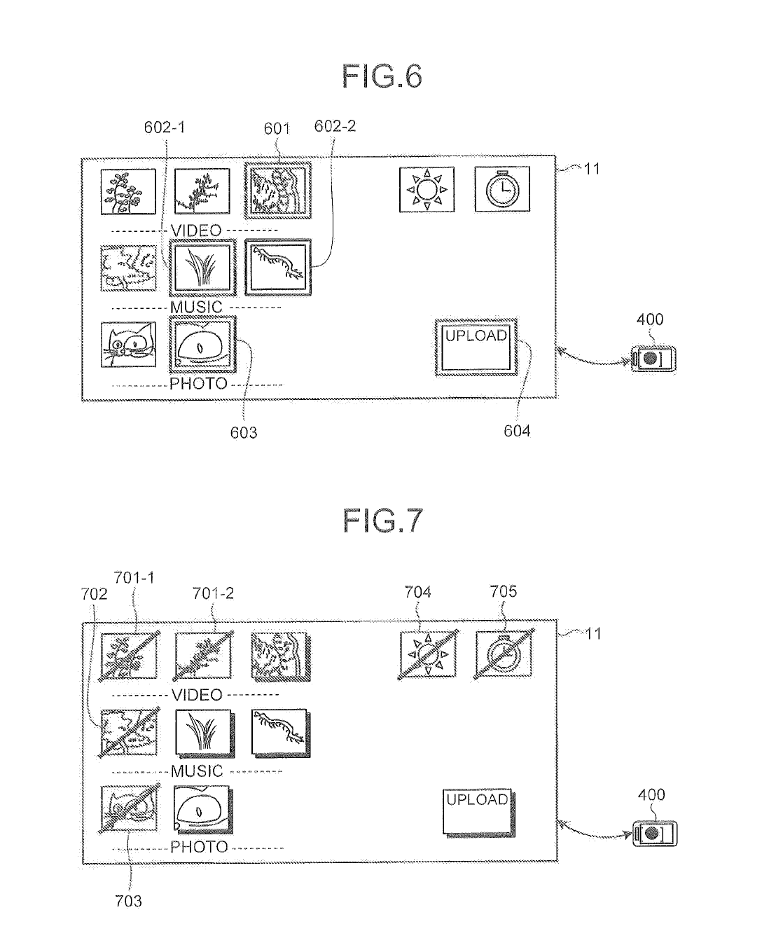

The embodiment does not limit the display mode and various modes can be considered. FIG. 6 is a view illustrating a variation of a first screen on which the icons indicating pieces of data capable of being used by the mobile terminal 400 are displayed in a display mode different from that of other icons. In the example as illustrated in FIG. 6, icons 601, 602_1, 602_2, 603, and an upload icon 604 are displayed to be surrounded by thick outer frames as the display mode different from that of other icons.

As the different display mode, the size of the icons may be changed, the icons may be shaken or flashed, or the brightness and the color of the icons may be changed. Furthermore, an additional icon for indicating a communicable state and an additional icon for specifying icons that can be touched may be displayed. Only the frames of the icons may be flashed, or flashing speed or shaking speed thereof may be changed. Alternatively, these display modes may be combined.

Furthermore, as the method of making the display modes different between the icons indicating the pieces of data capable of being used by the mobile terminal 400 and the icons indicating the pieces of data incapable of being used thereby, the display mode of other icons incapable of being used by the mobile terminal 400 may be changed.

FIG. 7 is a view illustrating a variation of a second screen on which icons indicating the pieces of data capable of being used by the mobile terminal 400 are displayed in a display mode different from that of other icons. In the example as illustrated in FIG. 7, as in FIG. 5, the icons indicating the pieces of data capable of being used by the mobile terminal 400 are displayed in the raised manner (such that shades thereof are emphasized) in the same manner as FIG. 5B. In addition, diagonal lines are drawn on icons 701_1, 701_2, 702, 703, 704, and 705 indicating the pieces of data incapable of being used by the mobile terminal 400 in a superimposed manner.

The method of making the display mode of the icons indicating the pieces of data incapable of being used by the mobile terminal 400 different is not limited to the example as illustrated in FIG. 7. Alternatively, the brightness or the color of the icons may be pale.

Returning back to FIG. 5, described is the case where the display region (user interface screen) of the display 11 is touched by the mobile terminal 400. The display processor 1 in the embodiment specifies the mobile terminal 400 as a terminal linking with it, and set video image data is uploaded onto it. A specifying method will be described later.

An example in FIG. 5C illustrates a state where the mobile terminal 400 is placed on the upload icon 504 on the display 11. As illustrated in FIG. 5C, when it is detected that the mobile terminal 400 touches the display 11 on the upload icon 504, the output module 105 outputs a screen on which the icon display is returned to the original state.

With this, data stored in the first mobile terminal 400 is uploaded. After the upload, the program activated by the activation module 104 determines the type of the uploaded data. Then, the program determines the data type from the moving image, the music and the picture and assigns an appropriate icon thereto in accordance with the determination result. With this, an icon 510 indicating picture data uploaded from the first mobile terminal 400 is additionally displayed on the region on which pieces of picture data are arranged.

In the embodiment, when the data is uploaded from the mobile terminal 400, the output module 105 displays animation on which the data appears from the position at which the mobile terminal 400 has been detected.

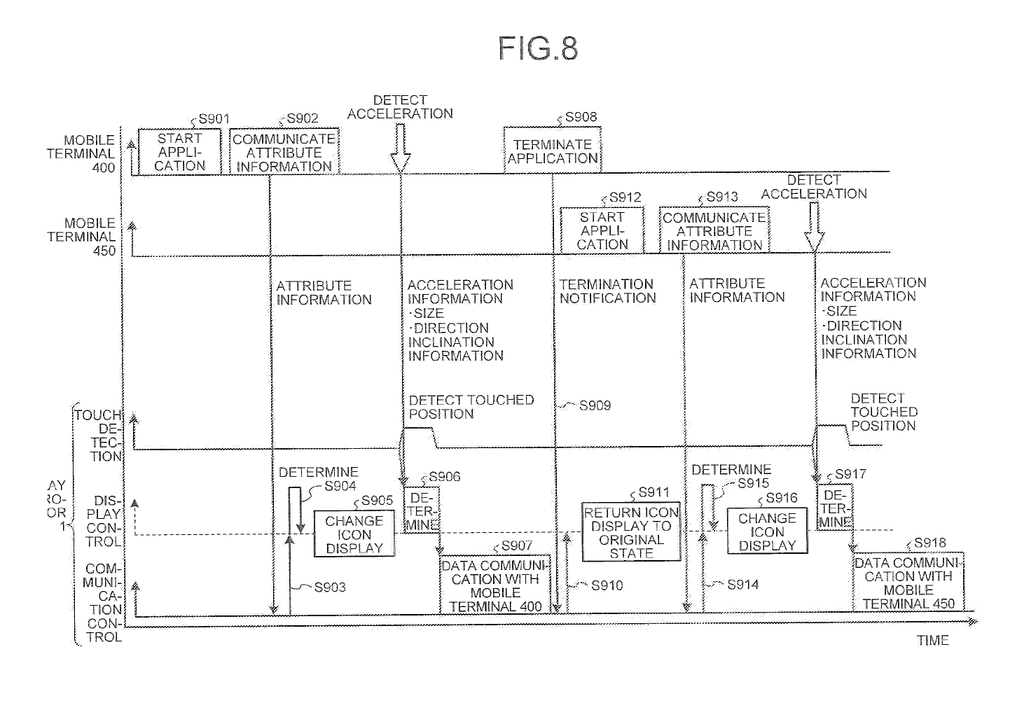

FIG. 8 is a diagram illustrating a timing chart when link processing between the display processor 1 and the mobile terminal 400 is performed.

The mobile terminals 400 and a mobile terminal 450 start communication when they make closer to the display processor 1. In the embodiment, communication is assumed to be made through the wireless LAN. The mobile terminals 400 and 450 enter the service area of the LAN in which the display processor 1 is present, so that IP addresses are acquired therebetween.

First, the mobile terminal 400 starts the display link program 413 (application) in accordance with an operation by a user (S901). Thereafter, the mobile terminal 400 transmits attribute information to the display processor 1 (S902). In the embodiment, the transmission of the attribute information maybe performed every time setting of the mobile terminal 400 or 450 is changed (for example, every time set data is changed). Alternatively, the transmission and the reception of the attribute information may be performed regularly.

Thereafter, the communication controller 101 of the display processor 1 passes the received attribute information to the determination module 103 (S903). The determination module 103 determines pieces of data that can be used by the mobile terminal 400 based on the attribute information (S904).

Then, the output module 105 changes display such that the icons indicating the pieces of data capable of being used by the mobile terminal 400 are displayed in the display mode different from that of other icons based on the determination result (S905). With this, the display screen as illustrated in FIG. 5B is displayed.

At the moment when the mobile terminal 400 is placed on the icon, the communication controller 422 of the mobile terminal 400 transmits acceleration information, as an acceleration detection signal, that has been detected by the acceleration detector 408 to the display processor 1. On the other hand, the acquisition module 102 of the display processor 1 acquires detection information indicating that an object has touched around the upload icon 504 or at a very close position thereto by the detection signal (containing position coordinates) transmitted from the position acquisition module 15.

When the time at which the detection information has been acquired and the time at which the acceleration detection signal has been received from the mobile terminal 400 are very close (the difference therebetween is within a predetermined threshold), the determination module 103 determines that the mobile terminal 400 as the transmission source of the acceleration detection signal has touched the display 11 and determines the mobile terminal 400 to be a link target (S906).

Then, the determination module 103 specifies a computer program to be executed among the computer programs related to the icon touched by the mobile terminal 400 based on the attribute of the mobile terminal 400 with reference to the icon data table 300.

The activation module 104 activates the program specified by the determination module 103. The activated program transmits and receives data to and from the mobile terminal 400 through the communication module 17 (S907).

After that, when the mobile terminal 450 is placed on the upload icon 504, the acquisition module 102 receives the detection signal (containing position coordinates) through the position acquisition module 15 so as to detect touch by the mobile terminal 450. Furthermore, the acquisition module 102 acquires touched position coordinates. The communication controller 101 receives an acceleration detection signal from the mobile terminal 450. Then, the determination module 103 specifies the mobile terminal 450 that has touched the upload icon 504 and performs the same pieces of processing as those when the mobile terminal 400 has touched it.

First, the mobile terminal 400 terminates the display link program 413 (application) in accordance with an operation by the user (S908). Thereafter, the mobile terminal 400 transmits termination notification to the display processor 1 (S909). The communication controller 101 notifies the output module 105 of the termination of communication (S910). With this, the output module 105 outputs a screen on which the icon display is returned to the original state to the display 11 (S911).

Thereafter, when the mobile terminal 450 starts the application (S912), the display processor 1 performs the same pieces of processing as those performed in the case of the mobile terminal 400 (S913 to S918) other than a point that display of icons are changed so as to correspond to the mobile terminal 450 (S916) when it changes the display of the icons.

The above-mentioned pieces of processing are performed, so that the user can identify the icons indicating the pieces of data capable of being used by the mobile terminals 400 and 450 among the icons displayed on the display processor 1 easily. This can prevent the user from touching the displayed icons with the mobile terminal 400 or 450 randomly for looking for the icons capable of being used. In addition, this prevents the problem that the user touches the icon repeatedly because it has no function for operation from occurring.

In the above-mentioned processing, the display processor 1 establishes data communication with one mobile terminal. Alternatively, the target with which the display processor 1 establishes data communication is not limited to one mobile terminal, and the display processor 1 may establish data communication with a plurality of mobile terminals.

When the display processor 1 makes data communication with the mobile terminals, the mobile terminals do not have the same function in some cases. In this case, pieces of data capable of being used by the mobile terminals are different. Various methods can be employed as the method of changing the display modes of icons on the screen that is output from the output module 105 in this case.

For example, the output module 105 can change a display mode of the icons indicating pieces of data capable of being used by all the mobile terminals. Alternatively, the output module 105 can change a display mode of only the icons capable of being used by any one of the mobile terminals. In this case, for example, the display link program is activated so as to change the display mode of only icons indicating pieces of data capable of being used by the mobile terminal that has become communicable with the display processor 1 first without changing the display mode of icons indicating pieces of data capable of being used by the mobile terminal that has become communicable with the display processor 1 later.

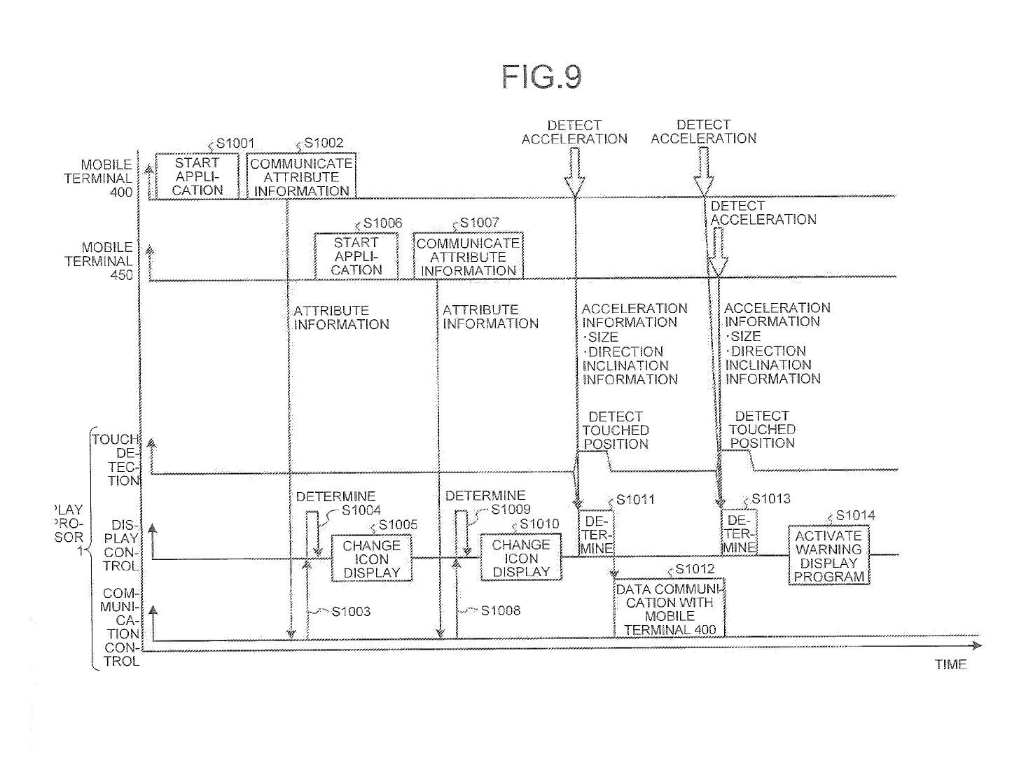

Furthermore, the display modes may be changed such that the icons indicating the pieces of data capable of being used by the respective mobile terminals can be identified. Described are the display modes for making the respective mobile terminals know the icons indicating the pieces of data capable of being used thereby. FIG. 9 is a diagram illustrating a timing chart when link processing between the display processor 1 and the mobile terminals 400 and 450 is performed.

First, the mobile terminal 400 starts the display link program 413 (application) in accordance with an operation by the user (S1001). Thereafter, the mobile terminal 400 transmits the attribute information to the display processor 1 (S1002).

Thereafter, the communication controller 101 of the display processor 1 passes the received attribute information of the mobile terminal 400 to the determination module 103 (S1003). The determination module 103 determines pieces of data capable of being used by the mobile terminal 400 based on the attribute information (S1004).

Then, the output module 105 changes display of icons indicating the pieces of data capable of being used by the mobile terminal 400 to be in a display mode different from that of other icons based on the determination result (S1005). With this, the display screen as illustrated in FIG. 5B is displayed.

In the same manner, the mobile terminal 450 also starts the display link program 413 (application) in accordance with an operation by the user (S1006). Thereafter, the mobile terminal 450 transmits the attribute information to the display processor 1 (S1007).

Then, the communication controller 101 of the display processor 1 passes the received attribute information of the mobile terminal 450 to the determination module 103 (S1008). The determination module 103 determines pieces of data capable of being used by the mobile terminal 450 based on the attribute information (S1009).

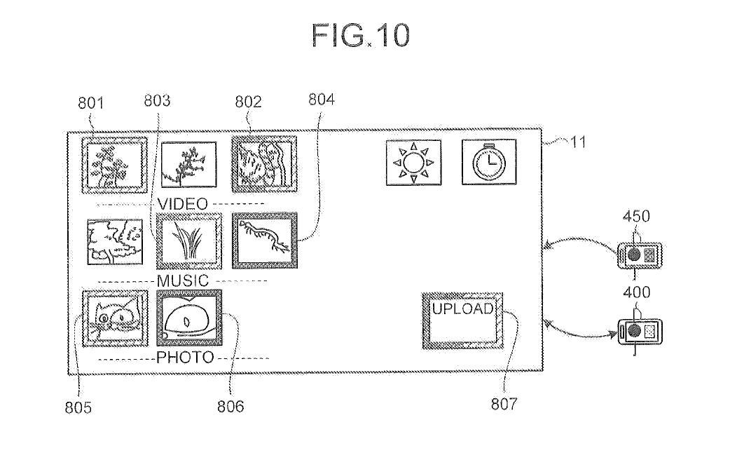

Then, the output module 105 changes display of icons indicating the pieces of data capable of being used by the mobile terminal 400 and the mobile terminal 450 to be in display modes different from that of other icons based on the determination result (S1010). With this, the display screen as illustrated in FIG. 10 is displayed.

FIG. 10 is a view illustrating a screen example on which the icons indicating the pieces of data capable of being used by the mobile terminals 400 and 450 are displayed in the display modes different from that of other icons. In the example as illustrated in FIG. 10, the display modes of the icons are made different such that the pieces of data capable of being used by the mobile terminal 400 and the pieces of data capable of being used by the mobile terminal 450 can be identified. In the example as illustrated in FIG. 10, the colors (shading) of the outer frames are made different.

That is to say, in the example as illustrated in FIG. 10, pieces of data indicated by icons 804 and 806 of which outer frames are shaded densely correspond to the pieces of data capable of being used by the mobile terminal 450 only. On the other hand, pieces of data indicated by icons 801 and 805 of which outer frames are shaded lightly are the pieces of data capable of being used by the mobile terminal 400 only. In addition, pieces of data as indicated by icons 802 and 803 of which outer frames are shaded densely and lightly in a combined manner are the pieces of data capable of being used by both the mobile terminals 400 and 450. Furthermore, an upload icon 807 of which outer frame is shaded densely and lightly in the combined manner can be also used by both the mobile terminals 400 and 450.

Furthermore, the user can identify the icons capable of being used by the respective mobile terminals by the colors (shading) that are displayed on the display modules 401 of the mobile terminals 400 and 450.

Returning back to FIG. 9, at the moment when the mobile terminal 400 is placed on the icon, the communication controller 422 of the mobile terminal 400 transmits acceleration information, as an acceleration detection signal, that has been detected by the acceleration detector 408 to the display processor 1. On the other hand, the acquisition module 102 of the display processor 1 acquires detection information indicating that an object has touched around the upload icon 504 or at a very close position thereto by the detection signal (containing position coordinates) transmitted from the position acquisition module 15.

When the time at which the detection information has been acquired and the time at which the acceleration detection signal has been received from the mobile terminal 400 are very close (the difference therebetween is within a predetermined threshold), the determination module 103 determines that the mobile terminal 400 as the transmission source of the acceleration detection signal has touched the display 11 and determines the mobile terminal 400 to be a link target (S1011).

Then, the determination module 103 specifies a computer program to be executed among the computer programs related to the icon touched by the mobile terminal 400 based on the attribute of the mobile terminal 400 with reference to the icon data table 300.

The activation module 104 activates the program specified by the determination module 103. The activated program transmits and receives data to and from the mobile terminal 400 through the communication module 17 (S1012).

After that, it is assumed that the communication controller 101 of the display processor 1 receives the acceleration detection signal from the first mobile terminal 400 and the acceleration detection signal from the second mobile terminal 450 at substantially the same timing. In other words, the communication controller 101 of the display processor 1 receives the acceleration detection signals from the first mobile terminal 400 and the second mobile terminal 450 within a predetermined threshold after the acquisition module 102 detects the touch.

For example, considered is the case where the timing at which the mobile terminal 400 touches the display 11 of the display processor 1 and the timing at which the mobile terminal 450 in a bag hits some place together with the bag to generate the acceleration are substantially identical to each other. In addition, the following case and the like can be considered. That is, the second mobile terminal 450 performs an operation that is totally different from that on the first mobile terminal 400, and the timing at which the user taps the screen of the second mobile terminal 450 strongly and the timing at which the first mobile terminal 400 touches the display 11 of the display processor 1 are identical to each other.

The determination module 103 determines that the time of the acceleration detection signal received from the mobile terminal 400 and the time of the acceleration detection signal received from the second mobile terminal 450 are very close to the time at which the detection signal is detected (the differences therebetween are within the predetermined threshold) (S1013).

Thus, when the determination module 103 specifies the mobile terminals that have touched, transmission and reception of data to and from the specified mobile terminals 400 and 450 are not performed in order to suppress transmission and reception control of data to and from an undesired terminal. Instead, the output module 105 outputs screen information expressing a message “PLEASE TOUCH AGAIN” or the like to the display 11 (S1014). This prompts the user to touch the display 11 with the mobile terminal, thereby achieving transmission and reception of data to and from the mobile terminal desired by the user.

Furthermore, when the determination module 103 specifies the mobile terminals that have touched, the operation is not limited to the prompting of touch again. Alternatively, in this case, it may be considered that both the mobile terminals have touched the display 11 and corresponding programs may be executed for both the mobile terminals. Thus, operations are determined in accordance with the embodiment.

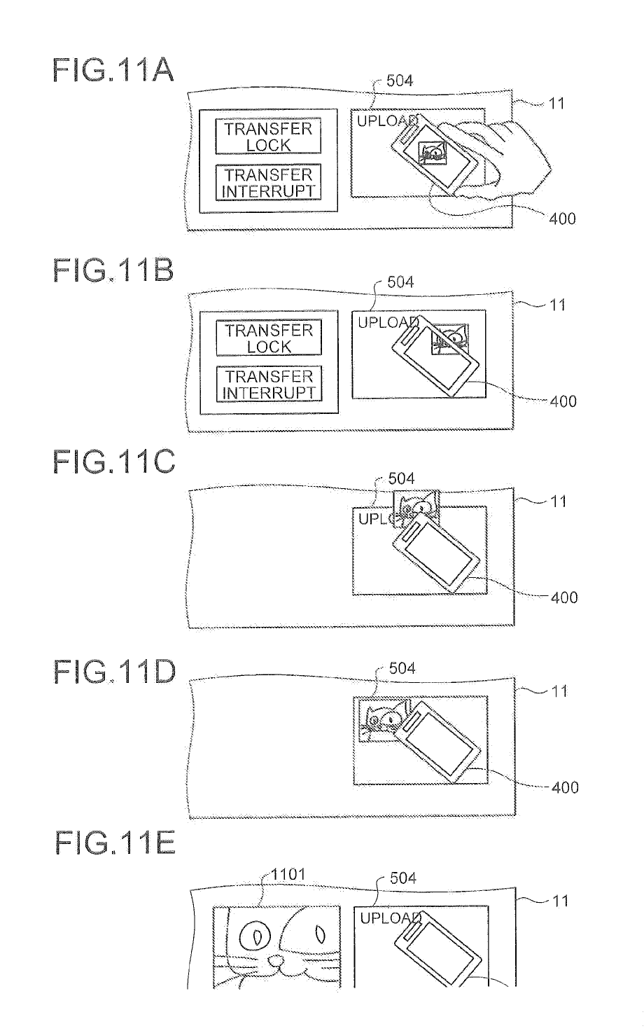

Next, described is animation display by the output module 105. FIGS. 11A to 11E are views illustrating an example of screen transition by display control by the output module 105. FIG. 11A illustrates a condition where the mobile terminal 400 is arranged on the upload icon 504. It is assumed that data as an upload target has been already selected on the mobile terminal 400.

As illustrated in FIG. 11A, picture data stored in the mobile terminal 400 is displayed as an icon on the screen of the mobile terminal 400. Then, data transfer is started when the mobile terminal 400 touches the display 11 of the display processor 1.

Next, as illustrated in FIGS. 11B to 11D, the output module 105 changes a ratio of the icon to be displayed in accordance with the progression degree (ratio of a data amount that has been transferred completely relative to a total data capacity) of the data transfer. To be specific, the output module 105 increases the ratio of the icon to be displayed as the upload proceeds.

The animation is displayed so as to be synchronized between the output module 105 of the display processor 1 and the display controller 423 of the output module 105. To be specific, the output module 105 and the display controller 423 perform display in accordance with the condition of progress of the upload so as to synchronize the display screens.

That is to say, the display controller 423 of the mobile terminal 400 also changes the ratio of the icon to be displayed in accordance with the degree of progress (a data amount that has not been transferred relative to the total data capacity). To be specific, the display controller 423 of the mobile terminal 400 decreases the ratio of the icon to be displayed as the upload proceeds. With this, the icons that are displayed are synchronized between the display processor 1 and the mobile terminal 400.

Furthermore, the position of the icon that is displayed by the output module 105 is determined based on the position coordinates of the mobile terminal 400 that have been acquired by the position acquisition module 15. The position of the icon displayed by the output module 105 of the display processor 1 and the position of the icon displayed by the display controller 423 of the mobile terminal 400 are aligned. In order to synchronize the positions and the like of the icon, the mobile terminal 400 transmits inclination information to the display processor 1. In addition, the mobile terminal 400 also transmits the model information, the screen size, the resolution, and the like that are used for specifying the mobile terminal 400 to the display processor 1.

As illustrated in FIG. 11B, the display processor 1 in the variation may display the icon such that the icon appears from the outer side of the mobile terminal 400 specified from the received inclination information and model information (or size of the mobile terminal 400).

With this, a portion of the icon that is displayed by the display controller 423 and a portion of the icon that is displayed by the output module 105 are combined. With this, the user can consider the icons as one icon.

As illustrated in FIG. 11E, the display controller 423 displays an icon 1101 indicating the corresponding data when data transfer is completed. Thereafter, the display controller 423 moves the icon 1101 in accordance with the type of the data.

The display controller 423 performs the above-mentioned display control, so that the user can check the data communication condition.

When the terminal link program 23 detects that the mobile terminal 400 has touched the display 11, the terminal link program 23 may display a dialog for checking on the mobile terminal 400 and request the user to check operations without starting data transfer immediately. This can suppress data transfer that is not desired by the user when determination whether the first mobile terminal 400 has touched the display 11 is made mistakenly.

Furthermore, when the display processor 1 receives the model information, the resolution, and the screen size information of the mobile terminal 400, the display processor 1 may adjust the size of the icon so as to match with the size of the icon that is displayed on the mobile terminal 400. With this, the icons having the same size or substantially the same size can be displayed on the mobile terminal 400 and the display processor 1.

When the mobile terminal 400 is moved away from the display 11 during the data transfer, the data transfer between the display processor 1 and the mobile terminal 400 is stopped. In this manner, the user can direct to stop the data transfer instinctively without performing a specific operation for cancelling the data transfer.

The output module 105 may display dialogs “TRANFER LOCK” and “TRANSFER INTERRUPT” as illustrated in FIGS. 11A and 11B before or during the data transfer between the display processor 1 and the mobile terminal 400. When the display processor 1 does not receive selection on the dialogs, the data transfer is stopped when the mobile terminal 400 is separated from the display 11 after the transfer started. On the other hand, the display processor 1 receives selection of “TRANFER LOCK”, the data transfer is continued even when the mobile terminal 400 is separated from the display 11. Thus, data transfer in accordance with the user's request can be achieved.

When the display processor 1 receives selection of “TRANSFER INTERRUPT”, data transfer between the display processor 1 and the mobile terminal 400 is interrupted. That is to say, when the display processor 1 receives selection of “TRANFER LOCK”, the data transfer is not stopped only by separating the mobile terminal 400 from the display 11 whereas when it receives the selection of “TRANSFER LOCK” from the user, the data transfer can be interrupted. With this, the data transfer can be interrupted by selecting “TRANSFER INTERUPPT” when the user desires to interrupt the data transfer although the user selects the “TRANSFER LOCK”.

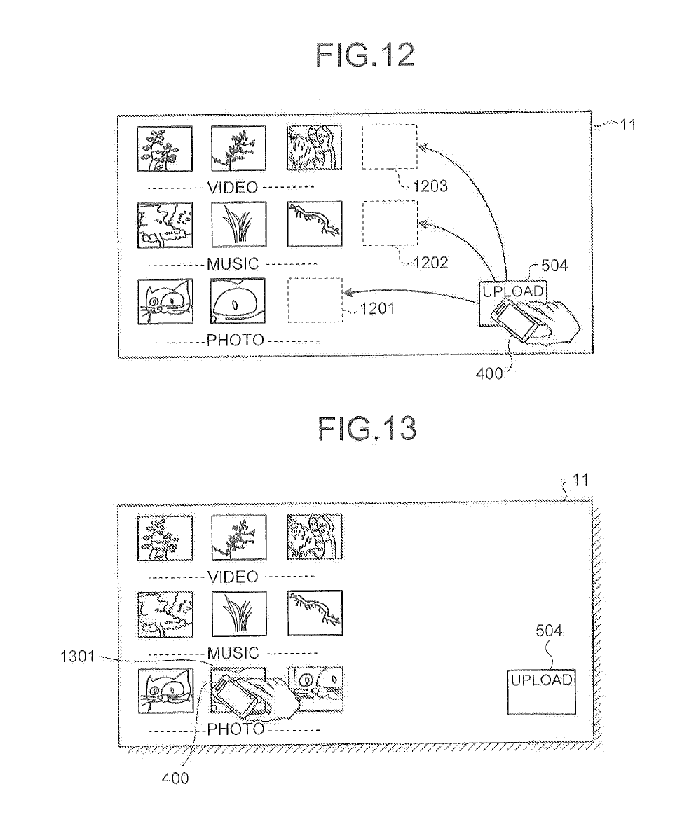

Then, the output module 105 displays animation on which the icon is moved to a position in accordance with the data type after the data transfer is completed. FIG. 12 is a view illustrating an example of movement destinations of icons by the output module 105. As illustrated in FIG. 12, when the received data is video image data, the output module 105 moves an icon of the video image data to a position 1203. When the received data is music data, the output module 105 moves an icon of the music data to a position 1202. When the received data is picture data, the output module 105 moves an icon of the picture data to a position 1201.

Next, described is the case where data is downloaded onto the mobile terminal 400 from the display processor 1. When data is downloaded onto the mobile terminal 400 from the display processor 1, the icon displayed on the display 11 is touched by the mobile terminal 400, so that download of the data indicated by the icon is started. FIG. 13 is a view illustrating arrangement of the mobile terminal 400 when data is downloaded from the display processor 1. As illustrated in FIG. 13, the mobile terminal 400 is arranged on an icon 1301, so that download of picture data indicated by the icon 1301 is started.

When the data is downloaded, the output module 105 displays animation on which the icon is moved to the mobile terminal 400. Although described has been the example in which overall the icon is enlarged and contracted in accordance with the data communication condition in the embodiment, various modes can be considered. For example, the icon may be enlarged and contracted in the lengthwise direction and the lateral direction of the icon only toward the mobile terminal 400 onto which data is downloaded.

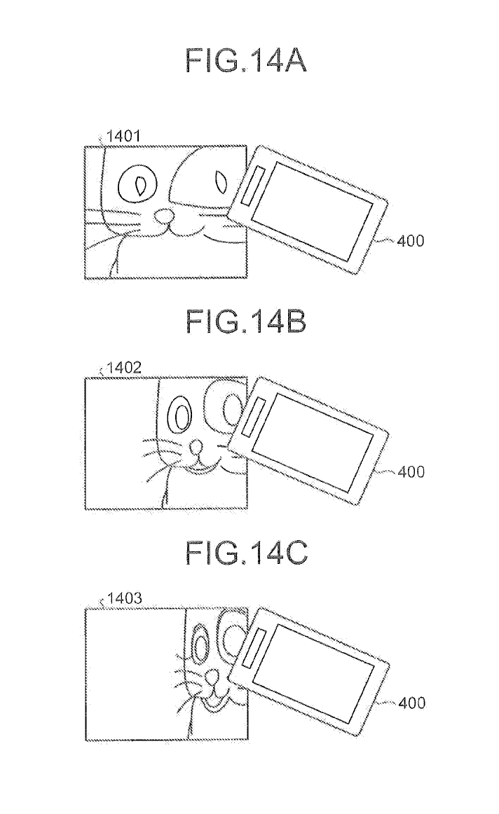

FIGS. 14A to 14C are views illustrating an example of transition of the screen information that is output from the output module 105. As illustrated in FIG. 14A, it is assumed that the mobile terminal 400 touches an icon 1401. With this, the acquisition module 102 detects the touch of the mobile terminal 400 and specifies data indicated by the icon 1401 touched by the mobile terminal 400 as a download target.

Then, the output module 105 controls display such that the icon 1401 is moved in a contracted manner in the lateral direction only with reference to the position touched by the mobile terminal 400 in accordance with the download condition between the display processor 1 and the mobile terminal 400.

That is to say, as indicated by an icon 1402 in FIG. 14B and an icon 1403 in FIG. 14C, the output module 105 controls display such that the icon is moved in the contracted manner in the lateral direction only as the download onto the mobile terminal 400 proceeds. In addition, when the icon 1401 is configured by a plurality of images, a pattern of the icon may be changed in accordance with the download condition. FIGS. 14A to 14C illustrate the example in which animation is displayed such that the content of the icon is pressed gradually and face expression in the icon is drawn.

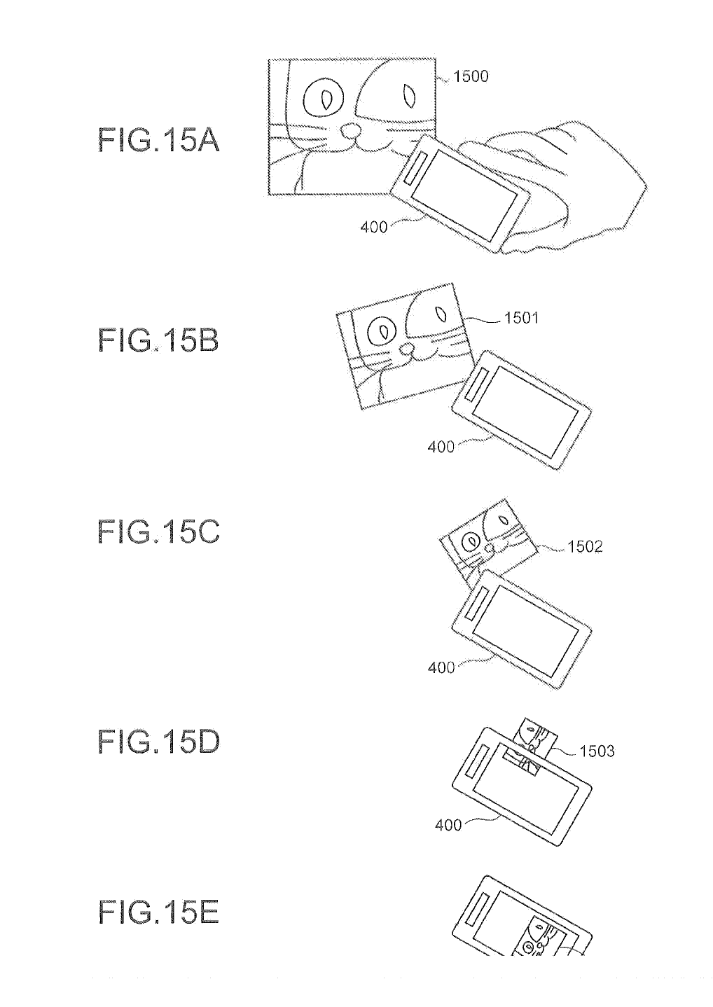

Also described is another mode of the animation that is displayed when data is downloaded. FIGS. 15A to 15E are views illustrating a first example of transition of screen information that is output from the output module 105 according to a variation. As illustrated in FIG. 15A, it is assumed that the mobile terminal 400 touches an icon 1500. With this, the acquisition module 102 detects the touch of the mobile terminal 400 and specifies data indicated by the icon 1500 touched by the mobile terminal 400 as the download target.

Next, as indicated by an icon 1501 in FIG. 15B and an icon 1502 in FIG. 15C, the output module 105 displays animation on which the icon is contracted in accordance with the screen size and the resolution of the mobile terminal 400. The mobile terminal 400 transmits the screen size and the resolution to the display processor 1 previously. The display processor 1 may specify the screen size and the resolution based on the model information received from the mobile terminal 400.

As illustrated in FIG. 15D, the output module 105 displays animation on which an icon 1503 is moved to a position at which the mobile terminal 400 has been detected in accordance with the degree of progress of the data transfer, to be specific, a ratio of the data amount that has been transferred completely relative to the total data capacity.

As illustrated in FIG. 15E, when the download is completed, the output module 105 terminates display of the icon indicating the data that has been downloaded while the display controller 423 of the mobile terminal 400 displays an icon 1504 overall indicating the data that has been completely downloaded. With this, the user can know the completion of the data download.

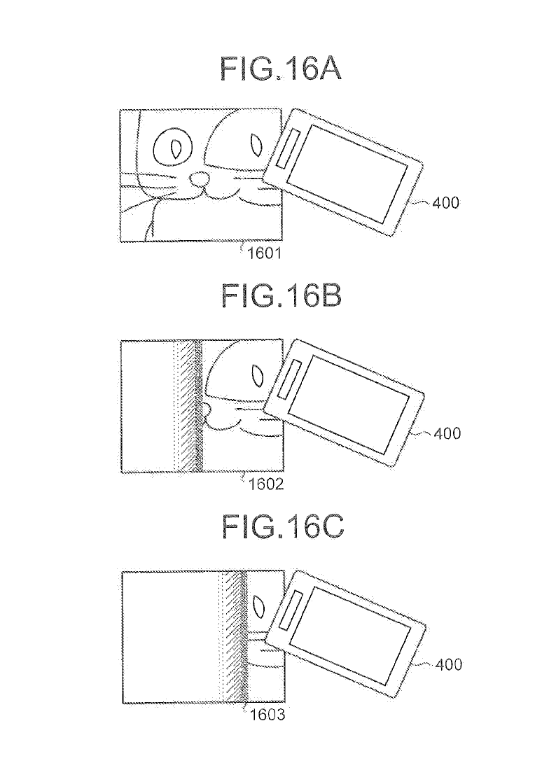

The animation display of the icon is not limited to the contraction and enlargement control, and the color, the brightness, or the like of the icon may be changed. FIGS. 16A to 16C are views illustrating a second example of transition of screen information that is output from the output module 105 in the variation. As illustrated in FIG. 16A, it is assumed that the mobile terminal 400 touches an icon 1601. With this, the acquisition module 102 detects the touch of the mobile terminal 400 and specifies data indicated by the icon 1601 touched by the mobile terminal 400 as a download target.

Then, in accordance with the download condition between the display processor 1 and the mobile terminal 400, the output module 105 displays animation on which the brightness and the color of the icon 1601 are changed from a region farthest from a reference while setting the position touched by the mobile terminal 400 as the reference.

That is to say, as indicated by an icon 1602 in FIG. 16B and an icon 1603 in FIG. 16C, the output module 105 displays animation on which the brightness of the icon is gradually increased (color of the icon is changed to white) from the left side farther from the position touched by the mobile terminal 400 as the download onto the mobile terminal 400 proceeds. With this, animation on which the pattern disappears as the time passes is displayed. This enables the user to sense that the data as indicated by the icons 1601 to 1603 is loaded on the mobile terminal 400.

The above-mentioned embodiment describes the example in which the display mode of the icon is made different in accordance with data capable of being used by the mobile terminal. The target of which display mode is made different is not limited to the icon. For example, there is the following system. That is, when a log-in button displayed by the display processor 1 is touched by the mobile terminal, identification information, a password, and the like are exchanged between the display processor 1 and the mobile terminal so as to log in the system. The above-mentioned technique can be applied to such a system.

To be specific, when a log-in program is activated on the mobile terminal 400, the mobile terminal 400 transmits the attribute information to the display processor 1. It is assumed that the attribute information contains information for identifying a system that the mobile terminal 400 can log in.

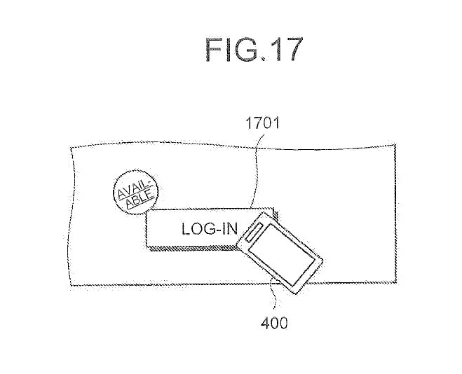

Then, when the determination module 103 of the display processor 1 determines that the mobile terminal 400 comprises information necessary for logging in the system based on the attribute information, the output module 105 makes a display mode of the log-in button different. FIG. 17 is a view illustrating a screen example on which the output module 105 arranges the log-in button in the changed display mode. In the screen example as illustrated in FIG. 17, the log-in button is displayed in a raised manner (shade thereof is emphasized) and a message (available) indicating that the user can log in is displayed. When the display is made, if a log-in button 1701 is touched by the mobile terminal 400, the identification information and the password are exchanged and log-in processing is performed.

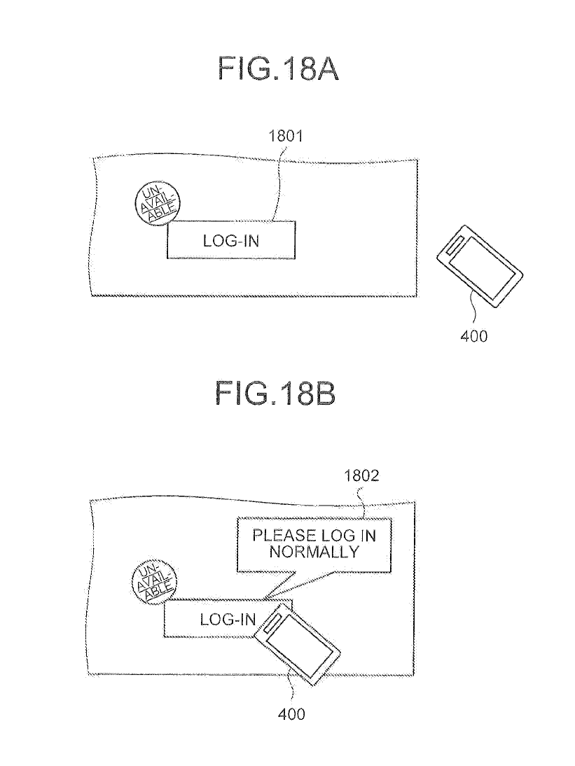

When the determination module 103 of the display processor 1 determines that the mobile terminal 400 does not comprise the information necessary for logging in based on the attribute information, the output module 105 may make the display mode of the log-in button different. FIGS. 18A and 18B are views illustrating a screen example on which the output module 105 arranges the log-in button in the changed display mode. In the screen example as illustrated in FIG. 18A, a message (unavailable) indicating that the user cannot log in the system is displayed.

When the display is made, if a log-in button 1801 is touched by the mobile terminal 400, the user cannot log in the system by the mobile terminal 400. Then, as illustrated in FIG. 18B, the output module 105 outputs screen information containing a message “PLEASE LOG IN NORMALLY” 1802.

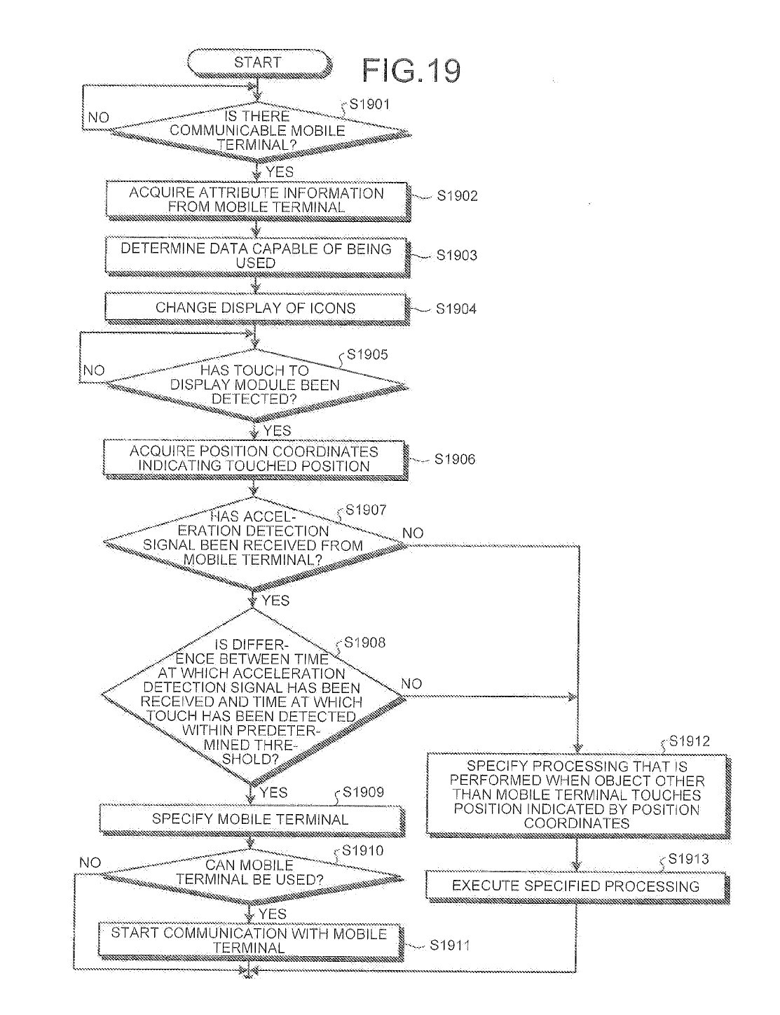

Next, described is processing until communication between the display processor 1 and the mobile terminal 400 is started in the embodiment. FIG. 19 is a flowchart illustrating procedures of the above-mentioned processing in the display processor 1 in the embodiment.

The communication module 17 detects whether there is a communicable mobile terminal (S1901). If the communication module 17 does not detect it (No at S1901), the communication module 17 repeats the processing at S1901 until it detects the communicable mobile terminal. On the other hand, if the communication module 17 detects the communicable mobile terminal (Yes at S1901), the communication module 17 starts communication with each detected mobile terminal. Then, the terminal link program 23 acquires attribute information of each mobile terminal through the communication module 17 (S1902).

Subsequently, the determination module 103 determines data capable of being used by the mobile terminal based on the attribute information (S1903). Then, the output module 105 changes the display mode of icons in accordance with a determination result (S1904).

Thereafter, the acquisition module 102 determines whether touch to the display 11 has been detected based on a detection signal from the position acquisition module 15 (S1905). If the acquisition module 102 determines that the touch to the display 11 has been detected (Yes at S1905), the acquisition module 102 acquires position coordinates at which the touch has been detected based on the detection signal (S1906). On the other hand, if the acquisition module 102 determines that the touch to the display 11 has not been detected (No at S1905), the processing at S1905 is repeated.

Then, the communication controller 101 determines whether it has received the acceleration detection signal from the mobile terminal through the communication module 17 (S1907). If the communication controller 101 does not receive the acceleration detection signal (No at S1907), not the mobile terminal but the user's finger or the like is considered to touch the display 11. Based on this, the communication controller 101 specifies processing (computer program) that is performed when the user's finger or the like touches a position indicated by the position coordinates (S1912). Then, the activation module 104 executes the specified processing (computer program) (S1913). As the specified processing, for example, data (video image data, music data, and picture data) related by an icon present at the touched position is reproduced, displayed, and so on.

On the other hand, if the communication controller 101 receives the acceleration detection signal (Yes at S1907), the determination module 103 determines whether the difference between the time at which the touch based on the detection signal has been detected and the time at which the acceleration has been generated on the mobile terminal based on the acceleration detection signal is within the predetermined threshold, in other words, whether the generation timings are close (S1908). If the determination module 103 determines that the difference is not within the predetermined threshold (No at S1908), the process is performed from the processing at S1912.

On the other hand, if the determination module 103 determines that the difference is within the predetermined threshold (Yes at S1908), the determination module 103 considers that the mobile terminal as the transmission source of the acceleration detection signal has touched the display 11 and specifies the mobile terminal to be a data transmission and reception target (S1909).

The determination module 103 determines whether data indicated by the touched icon is capable of being used by the mobile terminal 400 (S1910). If the data is incapable of being used (No at S1910), the process is finished.

On the other hand, if the determination module 103 determines that the data is capable of being used (Yes at S1910), the determination module 103 specifies a computer program corresponding to the touched position coordinates and the attribute information of the mobile terminal as the data transmission and reception target. Then, the activation module 104 activates the specified program. With this, communication is started between the display processor 1 and the mobile terminal (S1911).

In the embodiment, animation display of the icon is made in accordance with the data amount that has been completely transferred. Note that the display mode of the icon is not limited to be proportionate to the transfer amount.

The embodiment does not limit the animation display to be started at the same time as the start of the data transfer. It is sufficient that the animation display may be started at a timing related to the data transfer operation. For example, the animation display may be started at a timing at which the transfer is finished, or the animation display may be started at a timing at which the icon is touched.

Furthermore, in the embodiment, display information indicating data is not limited to the icon. It is sufficient that the display information is image data indicating data, it may be a thumbnail, for example. When the thumbnail is used, the user is made to know the contents of the data that is being transferred easily.

In the embodiment, on the display processor 1, the display 11 is arranged perpendicularly as in the television display device. This enables the display processor 1 to specify a region touched by the mobile terminal 400 by receiving inclination information of the mobile terminal 400. Note that the display processor 1 is not limited to the case in which the display 11 is arranged perpendicularly and the display 11 may be arranged horizontally or the like. In this case, the display processor 1 can specify the region touched by the mobile terminal by acquiring directional information from the mobile terminal with a compass function.

When the mobile terminal touches an icon on the display 11, the display processor 1 in the embodiment as described above specifies the mobile terminal that has touched the icon from the acquired acceleration detection signal, and then, activates the program for transferring data to the mobile terminal. Accordingly, even when there are a plurality of mobile terminals that can transmit and receive data to and from the display processor 1, data can be transferred between the display processor 1 and a mobile terminal desired by the user. This prevents wrong transmission, thereby improving convenience of the user.

The attribute information of the appropriate mobile terminal is delivered to the program to be activated, so that the program can be executed in accordance with the mobile terminal, thereby improving convenience.

In the above-mentioned display processor 1, animation in accordance with the data transfer condition is displayed, so that the user can grasp the transfer condition easily. In addition, the display mode is made different in accordance with the position at which the mobile terminal is placed. This enables the user to known the current processing that is being performed instinctively.

Furthermore, an icon indicating data is transferred before the data itself is transferred. This enables the user to known the data to be transferred easily. In addition, icons that are displayed on the display processor 1 and the mobile terminal 400 can be synchronized therebetween. This improves visibility.

With the display processor 1 in the above-mentioned embodiment, whether data can be used by the mobile terminal based on the display mode of the icon (display information). This can improve convenience of the user and prevent failure due to repeated touch from occurring.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display processor comprising:
an acquisition module configured to acquire detection information indicating that an object has been detected around a display region on which a display device performs displaying;
a communication module configured to be capable of transmitting and receiving data to and from a communication terminal;
an output module configured to output, to a display, screen information on which display information indicating data is arranged, and to output, to the display when communication with the communication terminal between the communication module and the communication terminal becomes available, the display information indicating data capable of being used by the communication terminal in a display mode different from other display information based on attribute information indicating an attribute of the communication terminal, the attribute information being received from the communication terminal; and
a communication controller configured to establish, when the communication terminal is detected around the display region, communication of the data indicated by the display information in the display mode different from the other display information by the output module between the communication module and the communication terminal based on the detection information acquired by the acquisition module and the attribute information received from the communication terminal.

2. The display processor of claim 1, further comprising a display device configured to be capable of detecting touch when the display region is touched.

3. The display processor of claim 1, wherein, when the communication controller is capable of establishing communication between the communication module and each of a plurality of communication terminals, the output module is configured to change the display mode of the display information in accordance with whether the respective communication terminals are capable of using the display information, and to output the display information in the changed display mode.

4. The display processor of claim 1, wherein the display information displayed by the output module is an icon, a thumbnail, or a button indicating the data.

5. The display processor of claim 1, wherein the output module outputs, to the display module, the display information indicating the data capable of being used by the communication terminal while emphasizing shade or making color of an outer frame different.

6. A display processing method comprising:
acquiring detection information indicating that an object has been detected around a display region on which a display device performs displaying;
outputting, to a display, screen information on which display information indicating data is arranged, and outputting, to the display when communication between a communication module and a communication terminal becomes available, the display information indicating data capable of being used by the communication terminal in a display mode different from other display information based on attribute information indicating an attribute of the communication terminal, the attribute information being received from the communication terminal; and
establishing, when the communication terminal is detected around the display region, communication of the data indicated by the display information in the display mode different from the other display information by the output module between the communication module and the communication terminal based on the detection information acquired by the acquisition module and the attribute information received from the communication terminal.
